(19) United States
(12) Patent Application Publication
(10) Pub. No.: US 2021/0085431 A1
(43) Pub. Date: Mar. 25, 2021

(54) TOOTH STUMP FOR A DENTAL MODEL AND DENTAL MODEL

(71) Applicants: Rapid Shape GmbH, Heimsheim (DE); Straumann Holding AG, Basel (CH)

(72) Inventors: Andreas Schultheiss, Muehlacker (DE); Andreas Geitner, Leonberg (DE); Markus Krause, Eberdingen (DE); Daniel Roeckl, Muenchen (DE); Maximilian Sattler, Muenchen (DE); Soeren Dietz, Woerth (DE)

(21) Appl. No.: 16/949,164

(22) Filed: Oct. 16, 2020

Related U.S. Application Data
(63) Continuation of application No. PCT/EP2019/060165, filed on Apr. 18, 2019.

(30) Foreign Application Priority Data
Apr. 20, 2018 (EP) 18168513.2

(51) Int. Cl. A61C 9/00; A61C 13/00; A61C 13/34

(52) U.S. Cl. CPC A61C 9/002; A61C 13/34; A61C 13/0019

(57) ABSTRACT

The invention relates to a tooth stump for a dental model, said dental model comprises at least one tooth and at least one tooth stump receptacle for at least partially receiving the tooth stump, said tooth stump comprises a tooth portion in the form of a human or animal tooth and a coupling portion defining a coupling portion longitudinal axis for force-locking and/or positive-locking engagement with the at least one tooth stump receptacle of the dental model in a coupling position, the tooth stump comprising a positioning device for defined spatial positioning of the tooth stump in the tooth stump receptacle in the coupling position, wherein the positioning device comprises at least one positioning element formed on the coupling portion. Further, the invention relates to a dental model.

### CROSS-REFERENCE TO RELATED APPLICATIONS

This application is a continuation of international application number PCT/EP2019/060165 filed on Apr. 18, 2019 and claims the benefit of European patent application number 18 168 513.2 filed on Apr. 20, 2018, which are incorporated herein by reference in their entirety and for all purposes.

### FIELD OF THE INVENTION

The present invention relates to tooth stumps for a dental models generally, and more specifically to a tooth stump for a dental model, which dental model has at least one tooth and at least one tooth stump receptacle for at least partially receiving the tooth stump, which tooth stump has a tooth portion in the form of a human or animal tooth and a coupling portion, defining a coupling portion longitudinal axis, for force-locking and/or positive-locking engagement with the at least one tooth stump receptacle of the dental model in a coupling position, wherein the tooth stump comprises a positioning device for defined spatial positioning of the tooth stump in the tooth stump receptacle in the coupling position.

Furthermore, the present invention relates to dental models generally, and more specifically to a dental model, in particular as a working and control model for the production of dental prostheses, which dental model comprises a main body with at least one tooth stump receptacle for at least partially receiving a tooth stump, which tooth stump receptacle defines a receptacle longitudinal axis and is configured for force-locking and/or positive-locking engagement with the tooth stump in a coupling position, the tooth stump receptacle comprising a receptacle positioning device for defined spatial positioning of the tooth stump in the tooth stump receptacle in the coupling position.

Furthermore, the present disclosure relates to a method for producing a tooth stump and to a method of producing a dental model.

### BACKGROUND OF THE INVENTION

Tooth stumps and dental models of the types described above are known, for example, from DE 10 2013 107 916 A1 and from WO 2011/103879 A1. Dental models of this type are used in particular as working and control models for the production of dental prostheses or dental implants by dental technicians and dentists.

A problem with dental models having at least one tooth stump receptacle for receiving a tooth stump is that the tooth stump must be inserted in a defined manner into the tooth stump receptacle in order to achieve an optimum working result, i.e. in particular a spatially highly precise model of a patient's upper or lower jaw with teeth. In this regard, both an orientation of the tooth stump in the tooth stump receptacle about the coupling portion longitudinal axis and an insertion depth of the tooth stump into the tooth stump receptacle are of importance. Manufacturing tolerances are practically unavoidable, especially when producing tooth stumps and dental models from plastics material using additive manufacturing processes. However, since even the slightest deviations in size may lead to an incorrect positioning of the tooth stump in the tooth stump receptacle, it is desirable to overcome these problems.

A jaw model is known from U.S. Pat. No. 6,257,895 B1. Dental models are described in US 2013/0216980 A1. US 2006/0003287 A1 discloses dental models for dental training apparatuses. Furthermore, an assembly arrangement for an exchangeable tooth of an artificial dental jaw model is known from U.S. Pat. No. 5,030,102. Furthermore, U.S. Pat. No. 2,880,508 describes artificial tooth structures.

### SUMMARY OF THE INVENTION

In a first aspect of the invention, a tooth stump for a dental model is provided. Said dental model comprises at least one tooth and at least one tooth stump receptacle for at least partially receiving the tooth stump. Said tooth stump comprises a tooth portion in the form of a human or animal tooth and a coupling portion defining a coupling portion longitudinal axis for force-locking and/or positive-locking engagement with the at least one tooth stump receptacle of the dental model in a coupling position. The tooth stump comprises a positioning device for defined spatial positioning of the tooth stump in the tooth stump receptacle in the coupling position. The positioning device comprises at least one positioning element formed on the coupling portion. The at least one positioning element can be deflected from a basic position against the action of a restoring device into a holding position displaced towards or away from the coupling portion longitudinal axis or substantially towards or away from the coupling portion longitudinal axis. The positioning device comprises at least one guide element, and the at least one guide element is arranged or formed on the at least one positioning element. In particular, the at least one positioning element, when it is in the holding position, is deflected from the basic position against the action of the restoring device.

In a second aspect of the invention, a dental model, in particular as a working and control model for the production of dental prostheses, is provided. Said dental model comprises a main body with at least one tooth stump receptacle for at least partially receiving a tooth stump. Said tooth stump receptacle defines a receptacle longitudinal axis and is configured for force-locking and/or positive-locking engagement with the tooth stump in a coupling position. The tooth stump receptacle comprises a receptacle positioning device for the defined spatial positioning of the tooth stump in the tooth stump receptacle in the coupling position. The receptacle positioning device comprises at least one receptacle positioning element formed on the tooth stump receptacle. The at least one receptacle positioning element can be deflected from a basic position against the action of a receptacle restoring device into a holding position displaced towards or away from the receptacle longitudinal axis or substantially towards or away from the receptacle longitudinal axis. The receptacle positioning device comprises at least one receptacle guide element, and the at least one receptacle guide element is arranged or formed on the at least one receptacle positioning element. In particular, the at least one receptacle positioning element, when it is in the holding position, is deflected from the basic position against the action of the receptacle restoring device.

In a third aspect of the invention, a dental model, in particular as a working and control model for the production of dental prostheses, is provided. Said dental model comprises a main body and at least one tooth stump coupled to the main body in a coupling position. Said tooth stump comprises a tooth portion in the form of a tooth and a coupling portion. Said main body has at least one tooth stump receptacle, in which the coupling portion of the tooth stump is received at least partially, in particular completely. The tooth stump comprises a tooth portion in the form of a human or animal tooth and a coupling portion defining a coupling portion longitudinal axis for force-locking and/or positive-locking engagement with the at least one tooth stump receptacle of the dental model in a coupling position. The tooth stump comprises a positioning device for defined spatial positioning of the tooth stump in the tooth stump receptacle in the coupling position. The positioning device comprises at least one positioning element formed on the coupling portion. The at least one positioning element can be deflected from a basic position against the action of a restoring device into a holding position displaced towards or away from the coupling portion longitudinal axis or substantially towards or away from the coupling portion longitudinal axis. The positioning device comprises at least one guide element, and the at least one guide element is arranged or formed on the at least one positioning element. In particular, the at least one positioning element, when it is in the holding position, is deflected from the basic position against the action of the restoring device.

### BRIEF DESCRIPTION OF THE DRAWING FIGURES

The foregoing summary and the following description may be better understood in conjunction with the drawing figures, of which:

FIG. 1: shows an exemplary perspective, partially open-work view of an embodiment of a dental model with inserted tooth stumps;

FIG. 2: shows a perspective view of an embodiment of a tooth stump;

FIG. 3: shows a view in the direction of the arrow A in FIG. 2;

FIG. 4: shows a perspective view of another embodiment of a tooth stump;

FIG. 5: shows a view in the direction of the arrow B in FIG. 4;

FIG. 6: shows a perspective view of another embodiment of a tooth stump;

FIG. 7: shows a view in the direction of the arrow C from FIG. 6;

FIG. 8: shows a partial view of an embodiment of a dental model as a tooth stump is inserted into a tooth stump receptacle thereof;

FIG. 9: shows a view similar to FIG. 8 after insertion of the tooth stump into the tooth stump receptacle;

FIG. 10: shows a sectional view along line 10-10 in FIG. 9;

FIG. 11: shows a sectional view along line 11-11 of another embodiment of a tooth stump from FIG. 12;

FIG. 12: shows a sectional view along line 12-12 of the further embodiment of a tooth stump from FIG. 11;

FIG. 13: shows a detail of another embodiment of a dental model with two inserted tooth stumps from FIG. 14 in the direction of the arrow D;

FIG. 14: shows a sectional view along line 14-14 in FIG. 13;

FIG. 15: shows a detail of another embodiment of a dental model with receptacle positioning elements; and

FIG. 16: shows a sectional view along line 16-16 in FIG. 15.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

The present invention relates to a tooth stump for a dental model, said dental model comprises at least one tooth and at least one tooth stump receptacle for at least partially receiving the tooth stump, said tooth stump comprises a tooth portion in the form of a human or animal tooth and a coupling portion defining a coupling portion longitudinal axis for force-locking and/or positive-locking engagement with the at least one tooth stump receptacle of the dental model in a coupling position, the tooth stump comprising a positioning device for defined spatial positioning of the tooth stump in the tooth stump receptacle in the coupling position, wherein the positioning device comprises at least one positioning element formed on the coupling portion, wherein the at least one positioning element can be deflected from a basic position against the action of a restoring device into a holding position displaced towards or away from the coupling portion longitudinal axis or substantially towards or away from the coupling portion longitudinal axis, wherein the at least one positioning element, when it is in the holding position, is deflected from the basic position against the action of the restoring device, wherein the positioning device comprises at least one guide element, and wherein the at least one guide element is arranged or formed on the at least one positioning element.

A positioning device with at least one positioning element arranged and configured in this way makes it possible, in particular, to position the tooth stump in at least one spatial direction, preferably in two or all three spatial directions, defined in the tooth stump receptacle of the dental model. In particular, the at least one positioning element can be arranged and configured in such a way that manufacturing tolerances which lead to incorrect positioning in a plane transverse to the coupling portion longitudinal axis and/or in a direction parallel to the coupling portion longitudinal axis can be compensated by the fact that the at least one positioning element can be deflected from the basic position into the deflected holding position against the action of the restoring device. The at least one positioning element thus forms, in particular, an adaptive positioning element which enables the tooth stump to be arranged in the tooth stump receptacle of the dental model in a defined and reproducible manner, independently of manufacturing tolerances. It is advantageous that the positioning device comprises at least one guide element and if the at least one guide element is arranged or formed on at least one positioning element. The insertion of the tooth stump into the tooth stump receptacle on the dental model can be simplified with the at least one guide element.

The tooth stump can be formed in a particularly simple manner if the restoring device comprises at least one restoring element, against the action of which the at least one positioning element can be deflected into the holding position. In particular, one, two, three, four or even more positioning elements can be arranged or formed on the tooth stump.

It is favourable if the at least one restoring element is spring-elastic or substantially spring-elastic. A tooth stump with at least one such restoring element can be easily and reliably engaged and disengaged reversibly with the dental model, several times.

The at least one positioning element can be easily transferred into the deflected holding position and back into the basic position if the at least one positioning element is held or formed or supported resiliently on the coupling portion. For example, a spring-loaded joint can be provided here.

The tooth stump can be formed particularly easily and compactly if the at least one positioning element comprises or forms the at least one restoring element.

In order to be able to position the tooth stump in a plane transverse to the coupling portion longitudinal axis easily and reliably, it is advantageous if the at least one positioning element can be pivoted or rolled in or out about a deflection axis running parallel or transverse, in particular perpendicular, to the coupling portion longitudinal axis.

Preferably, the tooth stump comprises one, two, three, four or more positioning elements. In particular, three positioning elements enable a reliable and defined positioning and in particular also centring of the tooth stump in the tooth stump receptacle in a direction transverse to the coupling portion longitudinal axis.

It is favourable if a plurality of positioning elements is provided, in particular two, three or four, and if the positioning elements are arranged or formed evenly distributed over a periphery of the coupling portion. In this way, forces exerted by the restoring device in particular, which act on the plurality of positioning elements in holding positions deflected from the basic position, can be used for a defined positioning of the tooth stump in the tooth stump receptacle.

Inserting the tooth stump into the tooth stump receptacle of the dental model is particularly easy if the plurality of positioning elements is arranged or formed on the coupling portion so as to be oriented in the same direction in relation to the coupling portion longitudinal axis.

It is favourable if two or more guide elements are arranged or formed on the at least one positioning element. These guide elements, for example, can be arranged offset relative to each other in the peripheral direction or parallel to the coupling portion longitudinal axis in order to guide the tooth stump either in the peripheral direction or parallel to the coupling portion longitudinal axis as it is inserted into the tooth stump receptacle of the dental model.

Preferably, a connecting line of the two or more guide elements runs parallel to the coupling portion longitudinal axis. In this way, an optimum guidance of the tooth stump as it is inserted into the tooth stump receptacle of the dental model can be achieved.

It is advantageous if the at least one guide element is configured in the form of a guide protrusion or in the form of a guide groove. Such guide elements can be formed in a simple manner and allow, in particular, an optimal guidance in conjunction with corresponding guide elements on the dental model. In particular, at least one protrusion corresponding to the guide groove or at least one groove corresponding to the guide protrusion can be provided on the dental model.

It is favourable if the at least one guide element is arranged or formed on an outer surface of the at least one positioning element facing away from the coupling portion longitudinal axis. This makes it possible, in particular, to use the at least one guide element also as a spacer in order to prevent the at least one positioning element from coming into contact with the dental model, in particular a main body of the latter. For example, contact between the tooth stump and the dental model can be limited to direct contact between the at least one guide element and the dental model in the region of the tooth stump receptacle.

The at least one guide element expediently has a sliding surface facing in the distal direction. Such a sliding surface makes it possible, in particular, to force the at least one positioning element out of its basic position into the deflected holding position when the at least one guide element comes into contact with the tooth stump receptacle of the dental model. The sliding surface facilitates this process.

The tooth stump can be formed particularly easily and economically if the coupling portion is configured in the form of a coupling sleeve. In this way, the tooth stump can be formed more quickly, especially when produced by means of 3D printing. Furthermore, when the tooth stump is manufactured using an additive manufacturing process, for example, the volume of the tooth stump to be solidified can be minimised. This speeds up the manufacturing process and can also help, in particular, to optimise manufacturing costs.

It is advantageous if the coupling portion comprises a coupling portion stabilising device. The coupling portion stabilising device serves in particular to mechanically stabilise the coupling portion.

The coupling portion stabilising device is expediently surrounded by the coupling sleeve. In this case the coupling sleeve serves in particular also as protection for the coupling portion stabilising device.

The tooth stump can be easily formed if the coupling portion stabilising device comprises at least one coupling portion stabilising element. This can, in particular, connect opposing or adjacent portions of the coupling sleeve to each other in order to prevent twisting of the coupling sleeve to the greatest possible extent.

The coupling portion stabilising device can be easily formed if the at least one coupling portion stabilising element is in the form of a stabilising bar or a stabilising wall portion. Two, three or more coupling portion stabilising elements may also be provided. These may, for example, be configured to cross one other in order to stabilise the coupling sleeve inwardly.

A particularly good stabilisation of the coupling sleeve can be achieved if a plurality of coupling portion stabilising elements is provided.

It is favourable if the plurality of coupling portion stabilising elements extends from the coupling portion longitudinal axis to the coupling sleeve. In this way, in particular, penetrating or intersecting coupling portion stabilising elements can also be formed.

A particularly stable arrangement of the tooth stump can be achieved in particular by the fact that the coupling portion stabilising device is star-shaped or cross-shaped in cross-section relative to the coupling portion longitudinal axis.

The coupling portion is expediently delimited on the distal side by a peripheral rim and comprises a stand element protruding distally beyond the edge. This configuration makes it possible, in particular, to place the tooth stump, for example, on a work table, without any possibility of the tooth stump tipping over.

The tooth stump can be easily formed if the stand element is planar.

It is favourable if the stand element, in relation to the coupling portion longitudinal axis, defines a stand element cross-sectional area, if the coupling sleeve defines a coupling sleeve cross-sectional area, and if the stand element cross-sectional area is smaller than the coupling sleeve cross-sectional area. A tooth stump formed in this way can be easily inserted into a tooth stump receptacle of the dental model without the stand element being able to come into contact with an inner wall surface of the coupling sleeve.

Furthermore, it is favourable if the stand element, in relation to the coupling portion longitudinal axis, defines a stand element cross-sectional area, if the coupling sleeve defines a coupling sleeve cross-sectional area, and if the stand element cross-sectional area is geometrically similar to the coupling sleeve cross-sectional area. This configuration also has the advantage that the tooth stump can be easily and reliably inserted into the tooth stump receptacle. If, for example, the stand element cross-sectional area is circular, geometrically similar means that the coupling sleeve cross-sectional area is also circular. This applies accordingly to any geometrical cross-sectional shape.

It may also be favourable if the coupling portion comprises a peripheral wall and if the at least one positioning element forms part of the wall. This allows the tooth stump to be made particularly compact. In particular, the at least one positioning element can be formed as a cut-out of the wall, for example by forming corresponding slots in the wall.

In order to achieve sufficient stability for the tooth stump, it is advantageous if the wall has a wall thickness in a range of about 0.5 mm to about 1.5 mm. In particular, the wall thickness can be about 1 mm.

It is also advantageous if the at least one positioning element has a free end and is formed by a gap in the wall. The gap can be formed in the wall, in particular, after the coupling sleeve has been formed, or it can be taken into account already in an additive manufacturing process for forming the tooth stump.

A tab-shaped positioning element can be formed in particular in a simple way if the gap is U-shaped or substantially U-shaped.

It is favourable if the gap comprises a gap portion running parallel or substantially parallel to the coupling portion longitudinal axis. In this way, a free end of the at least one positioning element can also run, in particular, parallel to the coupling portion longitudinal axis.

It is favourable if the gap comprises a gap portion running in the peripheral direction or substantially in the peripheral direction in relation to the coupling portion longitudinal axis. For example, a three-sided positioning element formed in the wall by a gap, in particular a U-shaped gap, can be defined in this way.

According to another embodiment, it can be provided that the gap has a gap portion inclined by an angle of inclination in the peripheral direction in relation to a cross-sectional plane extending perpendicularly to the coupling portion longitudinal axis. Such a configuration makes it possible, in particular in a simple manner, to vary a width of the at least one positioning element, for example to vary an elasticity or flexibility of a positioning element formed in the wall along the extent of the positioning element in the peripheral direction.

It is favourable if the angle of inclination is in a range from 0° to about 20°. In particular, the angle of inclination can be around 10°. In this way, a sufficiently stable positioning element can be formed.

It is advantageous if the wall has a distal wall end directed away from the tooth portion and if the at least one positioning element extends as far as the wall end. The advantage of this embodiment is, in particular, that the positioning element does not have to be formed by, in particular, three sides by a slot in the wall, but for example only by two straight slots, which run in particular substantially parallel to the coupling portion longitudinal axis and transversely, in particular perpendicularly, to it.

A simple and stable embodiment of the tooth stump can be achieved in particular by making the wall end in the form of a peripheral edge of the wall.

In particular, it can be advantageous if the edge is interrupted by at least one gap portion of the at least one gap. In this way, a positioning element can be formed in particular, which extends to the wall end.

According to another embodiment, it can be provided that the edge tapers conically in the distal direction and defines an edge surface inclined at a cone angle. In particular, this embodiment allows a high-precision positioning of the tooth stump in the tooth stump receptacle in a direction parallel to the coupling portion longitudinal axis. In particular, a corresponding cone with a corresponding cone angle can be formed on the dental model, so that the inclined edge surface of the tooth stump can contact the corresponding cone surface of the dental model and can thus position the tooth stump in a spatial direction parallel to the coupling portion longitudinal axis.

The cone angle expediently has a value in a range from 0° to about 75°. In particular, the cone angle may be about 60°. Such cone angles are easy to produce. They also have the advantage, in particular, that an optimal positioning of the tooth stump in the tooth stump receptacle in a direction parallel to the coupling portion longitudinal axis is possible.

In order to simplify the production of the tooth stump, in particular if an additive manufacturing process is used for this purpose, it is expedient if the stand element is spaced from the wall end.

In order to achieve a clear positioning of the tooth stump in the tooth stump receptacle, it is advantageous if the coupling portion has a basic cross-sectional shape in relation to the coupling portion longitudinal axis which deviates from a circular shape. In this way, a clear positioning of the tooth stump in the tooth stump receptacle in a peripheral direction in relation to the coupling portion longitudinal axis can thus be specified.

The tooth stump can be formed easily and cost-effectively if the basic cross-sectional shape is oval or polygonal. In particular, the basic cross-sectional shape can be triangular, quadrangular or pentagonal.

The tooth stump is preferably formed in one piece. In particular, it may be monolithic. In this way, the stability of the tooth stump can be improved.

It is advantageous if the tooth stump is formed by an additive manufacturing process. In particular, it can be formed by 3D printing. In this way, delicate tooth stumps can be formed with high precision.

It is advantageous if the tooth stump is made of a plastics material. In this way, a tooth stump can be formed at low cost. The disadvantage, however, of producing the tooth stump from a plastics material, for example from a polymer solution that hardens when exposed to electromagnetic radiation, is that manufacturing tolerances can inevitably occur, in particular depending on the structural size of individual elements on the tooth stump. These tolerances can, however, be compensated for with the positioning device provided on the tooth stump.

Furthermore, the invention relates to a dental model, in particular as a working and control model for the production of dental prostheses, said dental model comprises a main body with at least one tooth stump receptacle for at least partially receiving a tooth stump, said tooth stump receptacle defines a receptacle longitudinal axis and is configured for force-locking and/or positive-locking engagement with the tooth stump in a coupling position, the tooth stump receptacle comprising a receptacle positioning device for the defined spatial positioning of the tooth stump in the tooth stump receptacle in the coupling position, wherein the receptacle positioning device comprises at least one receptacle positioning element formed on the tooth stump receptacle, wherein the at least one receptacle positioning element can be deflected from a basic position against the action of a receptacle restoring device into a holding position displaced towards or away from the receptacle longitudinal axis or substantially towards or away from the receptacle longitudinal axis, wherein the at least one receptacle positioning element, when it is in the holding position, is deflected from the basic position against the action of the receptacle restoring device, wherein the receptacle positioning device comprises at least one receptacle guide element, and wherein the at least one receptacle guide element is arranged or formed on the at least one receptacle positioning element.

The proposed refinement of a known dental model makes it possible, in a simple and reliable manner, to position tooth stumps in a defined way in the tooth stump receptacle. In particular, tooth stumps that do not themselves have a positioning device as described in detail above can also be positioned. In the dental model refined as proposed, the compensation of manufacturing tolerances on the tooth stump and/or on the dental model is made possible by the at least one receptacle positioning element. In particular, the receptacle restoring device can exert a force on the tooth stump inserted into the tooth stump receptacle if the tooth stump has deflected the at least one receptacle positioning element from the basic position into the deflected holding position. The insertion of the tooth stump into the tooth stump receptacle of the dental model is improved because the receptacle positioning device comprises at least one receptacle guide element and because the at least one receptacle guide element is arranged or formed on the at least one receptacle positioning element. In particular, it can thus be achieved that the tooth stump does not come into direct contact with the receptacle positioning element, but only comes indirectly into contact with the latter, although it can interact directly with the receptacle guide element.

It is advantageous if the receptacle restoring device comprises at least one receptacle restoring element, against the action of which the at least one receptacle positioning element can be deflected into the holding position. The receptacle restoring device can therefore comprise, in particular, a plurality of receptacle restoring elements, for example two, three, four or more. In particular, the receptacle restoring device makes it possible to centre the position of the tooth stump in the tooth stump receptacle.

In order to enable repeated engagement and disengagement of the tooth stump and the tooth stump receptacle, it is favourable if the at least one receptacle restoring element is spring-elastic or substantially spring-elastic. After a deflection from the basic position into the holding position, the receptacle restoring element can automatically transition into the basic position after removal of the tooth stump.

It is advantageous if the at least one receptacle positioning element is resiliently held or formed or supported on the tooth stump receptacle. In particular, this enables the tooth stump to interact with the at least one receptacle positioning element when the tooth stump is inserted into the tooth stump receptacle.

The dental model can be made particularly compact if the at least one receptacle positioning element comprises or forms the at least one receptacle restoring element. In particular, the at least one receptacle positioning element and the at least one receptacle restoring element can be made in one piece, in particular may be monolithic.

It is advantageous if the at least one receptacle positioning element can be pivoted or rolled in or out about a receptacle deflection axis running parallel or transversely, in particular perpendicularly, to the receptacle longitudinal axis. Depending on the orientation of the at least one receptacle positioning element, a particularly good centring of the tooth stump in the tooth stump receptacle can be achieved by means of the at least one receptacle positioning element.

The dental model expediently comprises one, two, three, four or more receptacle positioning elements. In particular, three receptacle positioning elements, which for example are evenly arranged or formed over a periphery in relation to the receptacle longitudinal axis, have the advantage that the tooth stump can be easily centred in the tooth stump receptacle and thus can be positioned in a defined manner, in particular in a plane transverse to the receptacle longitudinal axis.

Furthermore, it is favourable if a plurality of receptacle positioning elements is provided, in particular two, three or four, and if the receptacle positioning elements are arranged or formed evenly distributed over a periphery of the tooth stump receptacle. In particular, an optimal positioning, in particular a centring, of the tooth stump in the tooth stump receptacle can be achieved in a simple manner.

The insertion of the tooth stump into the tooth stump receptacle of the dental model can be further simplified if the plurality of receptacle positioning elements is arranged or formed on the tooth stump receptacle so as to be oriented in the same direction in relation to the receptacle longitudinal axis. In particular, this can help to avoid jamming as the tooth stump is inserted into the tooth stump receptacle.

In order to ensure a particularly good guidance of the tooth stump as it is inserted into the tooth stump receptacle of the dental model, it is advantageous if two or more receptacle guide elements are arranged or formed on the at least one receptacle positioning element.

Preferably, a connecting line of the two or more receptacle guide elements runs parallel to the receptacle longitudinal axis. This allows the receptacle guide elements to contact the tooth stump one after the other as the tooth stump is inserted into the stump receptacle and to guide it in the desired manner.

It is favourable if the at least one receptacle guide element is in the form of a receptacle guide protrusion or in the form of a receptacle guide groove. Such receptacle guide elements can be formed in a simple manner. In addition, they can interact in particular with corresponding guide elements on the tooth stump to insert and position the tooth stump in the tooth stump receptacle.

In order to enable the at least one receptacle guide element to interact easily with the tooth stump, it is favourable if the at least one receptacle guide element is arranged or formed on an inner surface of the at least one receptacle positioning element facing towards the receptacle longitudinal axis.

In order to be able to deflect the at least one receptacle positioning element in a simple and reliable manner when inserting the tooth stump, it is advantageous if the at least one receptacle guide element has a receptacle sliding surface facing in the proximal direction. The expression in the proximal direction is to be understood to mean that the receptacle sliding surface faces in the direction of the tooth stump as it is inserted into the tooth stump receptacle.

It is favourable for the tooth stump receptacle to be in the form of a tooth stump receiving sleeve. Such a receiving sleeve can be formed in a simple way and with a relatively low material usage.

In order to avoid a deformation of the tooth stump receptacle to the greatest possible extent, in particular as the tooth stump is inserted, it is advantageous if the tooth stump receptacle comprises a tooth stump receptacle stabilising device.

In order to be able to insert a tooth stump into the tooth stump receptacle in the desired manner, it is favourable if the tooth stump receptacle stabilising device surrounds the tooth stump receiving sleeve.

The dental model can be easily formed if the tooth stump receptacle stabilising device comprises at least one tooth stump receptacle stabilising element. This may act on the tooth stump receiving sleeve or may be arranged, formed or moulded thereon, in particular directly or indirectly.

It is favourable if the at least one tooth stump receptacle stabilising element is configured in the form of a receptacle stabilising bar or a receptacle stabilising wall portion. Such tooth stump receptacle stabilising elements can easily stabilise the tooth stump receptacle, in particular if it is configured in the form of a tooth stump receiving sleeve.

For a particularly stable construction of the tooth stump receptacle, it is favourable if a plurality of tooth stump receptacle stabilising elements is provided.

It is favourable if the plurality of tooth stump receptacle stabilising elements extends along the receptacle longitudinal axis as far as the tooth stump receiving sleeve. The plurality of tooth stump receptacle stabilising elements can thus be arranged or configured to surround the tooth stump receiving sleeve and, in particular, to be directed radially away from it.

The dental model may be configured particularly compact if the tooth stump receptacle comprises a peripheral receptacle wall and if the at least one receptacle positioning element forms part of the receptacle wall. In particular, the at least one receptacle positioning element can be integrated in the receptacle wall, i.e. forms part of it.

It is favourable if the receptacle wall has a receptacle wall thickness in the range from about 0.5 mm to about 1.5 mm. In particular, the receptacle wall thickness can be about 1 mm. Providing a receptacle wall thickness in the specified range has the advantage, in particular, that the at least one receptacle positioning element is integrated in the receptacle wall and can also form, simultaneously, a receptacle restoring element.

It is advantageous if the at least one receptacle positioning element has a free receptacle end and is formed by a receptacle gap in the receptacle wall. Thus, the receptacle positioning element can be configured in particular in the form of a strip- or wing- or tab-shaped element. For this purpose, only the gap must be left free during the production of the dental model. Alternatively, the gap can also be formed mechanically on the dental model so as to form the at least one receptacle positioning element.

The dental model can be configured easily and compactly if the receptacle gap is U-shaped or substantially U-shaped. For example, receptacle positioning elements can be formed by a receptacle gap which has three linear or substantially linear gap portions.

It is advantageous if the receptacle gap comprises a receptacle gap portion running parallel or substantially parallel to the receptacle longitudinal axis. In particular, this can be adjacent to the receptacle end of the at least one receptacle positioning element.

Furthermore, it is favourable if the receptacle gap comprises a receptacle gap portion running in the peripheral direction or substantially in the peripheral direction in relation to the receptacle longitudinal axis. In this way, in particular, a receptacle positioning element can be formed, which is configured to be pivoted or rolled in about a pivot axis running parallel or substantially parallel to the receptacle longitudinal axis.

It is favourable if the receptacle gap has a receptacle gap portion that is inclined by a receptacle angle of inclination in the peripheral direction in relation to a receptacle cross-sectional plane running perpendicularly to the receptacle longitudinal axis. Such an inclined receptacle gap portion makes it possible to vary, and in particular to reduce, the width of the receptacle positioning element in the desired manner along its extent in the direction of the free receptacle end. In particular, this allows the elasticity or flexibility of the at least one receptacle positioning element to be predefined or adjusted in the desired manner.

Preferably, the receptacle angle of inclination is in the range of from 0° to about 20°. In particular, it may be about 10°.

The construction of the at least one receptacle positioning element can be simplified in a simple way by the fact that the receptacle wall has a proximal receptacle wall end and that the at least one receptacle positioning element extends as far as the receptacle wall end. In this way, two linearly running receptacle gap portions are ultimately sufficient to form a strip-shaped or tab-shaped or wing-shaped receptacle positioning element.

It is favourable if the receptacle wall end is in the form of a peripheral receptacle edge of the receptacle wall. The receptacle wall end thus delimits the tooth stump receptacle in the proximal direction.

It is advantageous if the receptacle edge is interrupted by at least one receptacle gap portion of the at least one receptacle gap. In this way, a positioning of the tooth stump in the tooth stump receptacle as far as the receptacle wall end can be achieved.

According to a further embodiment, it may be provided that a depth stop is arranged or formed on the tooth stump receptacle to delimit a depth of insertion of the tooth stump, in particular of a coupling portion thereof, into the tooth stump receptacle in a direction parallel to the receptacle longitudinal axis. The depth stop of the tooth stump receptacle makes it possible, particularly in conjunction with the tooth stump, to specify an insertion depth for the latter in a desired manner.

In order to be able to compensate for manufacturing tolerances, even when forming the tooth stump and the tooth stump receptacle, it is favourable if the depth stop comprises a stop surface that tapers conically in the distal direction.

It is favourable if the stop surface has a receptacle cone angle which is inclined in relation to the receptacle longitudinal axis and which, in particular, has a value in a range from 0° to about 75°, which is further in particular about 60°.

It is advantageous if the tooth stump receptacle has a receptacle cross-sectional shape in relation to the receptacle longitudinal axis which deviates from a circular shape. This makes it possible, in particular, to position a correspondingly shaped tooth stump clearly in the tooth stump receptacle in the peripheral direction in relation to the receptacle longitudinal axis.

The dental model can be easily formed if the receptacle basic cross-sectional shape is oval or polygonal, especially triangular, quadrangular or pentagonal. Preferably, the receptacle basic cross-sectional shape is similar to the basic cross-sectional shape of the tooth stump. This simplifies the positioning of the tooth stump in the tooth stump receptacle of the dental model.

In order to improve the stability of the dental model, it is advantageous if the main body is made in one piece, in particular is monolithic.

The main body can be easily formed by an additive manufacturing process, in particular by 3D printing.

The dental model can be formed easily and, in particular, inexpensively if the main body is made of a plastics material.

According to another embodiment, the dental model may comprise a tooth stump coupled to the main body in the coupling position, which tooth stump comprises a tooth portion in the form of a tooth and a coupling portion, the coupling portion of the tooth stump being at least partially, in particular completely, accommodated in the at least one tooth stump receptacle. Two, three or more tooth stumps may also be coupled to the main body in the manner described. In particular, the dental model can be used to re-model part or all of a patient's lower or upper jaw.

Preferably, the dental model comprises at least one tooth stump that is at least partially accommodated in the tooth stump receptacle. This makes it possible to create, in particular, a dental model with one, two, three or more teeth.

Preferably, the tooth stump is configured in the form of one of the tooth stumps described above. The dental model then also has the advantages described above in conjunction with preferred embodiments of tooth stumps.

Further, the invention relates to a dental model, in particular as a working and control model for the production of dental prostheses, said dental model comprises a main body and at least one tooth stump coupled to the main body in a coupling position, said tooth stump comprises a tooth portion in the form of a tooth and a coupling portion, said main body has at least one tooth stump receptacle, in which the coupling portion of the tooth stump is received at least partially, in particular completely, wherein the tooth stump is comprises a tooth portion in the form of a human or animal tooth and a coupling portion defining a coupling portion longitudinal axis for force-locking and/or positive-locking engagement with the at least one tooth stump receptacle of the dental model in a coupling position, the tooth stump comprising a positioning device for defined spatial positioning of the tooth stump in the tooth stump receptacle in the coupling position, wherein the positioning device comprises at least one positioning element formed on the coupling portion, wherein the at least one positioning element can be deflected from a basic position against the action of a restoring device into a holding position displaced towards or away from the coupling portion longitudinal axis or substantially towards or away from the coupling portion longitudinal axis, wherein the at least one positioning element, when it is in the holding position, is deflected from the basic position against the action of the restoring device, wherein the positioning device comprises at least one guide element, and wherein the at least one guide element is arranged or formed on the at least one positioning element.

Forming a dental model in this way, in particular with one of the tooth stumps described above, makes it possible in particular to achieve a positioning either by means of it and its positioning device and/or by means of the dental model and its receptacle positioning device.

It is advantageous if the tooth stump receptacle is configured in the form of a recess with a tooth stump receptacle cross-sectional area and if the coupling sleeve cross-sectional area is smaller than the tooth stump receptacle cross-sectional area. This allows the tooth stump to be easily inserted into the tooth stump receptacle.

In order to be able to construct, in particular, a dental model as a working model of an upper or lower half of a patient's dentition, it is favourable if the main body is configured in the form of a part of the jaw.

Further, it is suggested in a method of the type described at the outset that the tooth stump is configured in the form of one of the tooth stumps described above by an additive manufacturing process. In particular, the tooth stumps can thus be easily formed from plastics or metal.

It is furthermore advantageous if the dental model is configured in the form of one of the dental models described above by an additive manufacturing process. For example, additive manufacturing processes can be used here which enable the formation of the dental model, and also of the tooth stump, on the basis of three-dimensional images or data of a patient's jaw. In particular, this makes it possible to completely dispense with impressions, which are unpleasant for patients.

Dental models and tooth stumps can be easily and cost-effectively formed if the tooth stump and/or the dental model are formed by 3D printing. In particular, 3D printing can be carried out on a plastics or metal basis.

A first embodiment of a dental model 10 comprises a main body 12 with a plurality of tooth stump receptacles 14. Tooth stumps 16 are inserted into these tooth stump receptacles 14.

The dental model 10 is particularly useful for dental technicians and dentists as a working model for the control model for the production of dental prostheses.

The dental model 10 may also include one or more teeth that are directly moulded on or formed integrally with the main body. However, it is also possible to form the main body 12 without such additional teeth, so that all teeth included in the dental model 10 are formed as tooth stumps 16.

Each tooth stump 16 comprises a tooth portion 18 in the form of a human or animal tooth as well as a coupling portion 20 on the distal side adjoining the tooth portion.

Each coupling portion 20 defines a coupling portion longitudinal axis 22. The coupling portion 20 is configured for force-locking and/or positive-locking engagement with a tooth stump receptacle 14 of the dental model 10 in a coupling position.

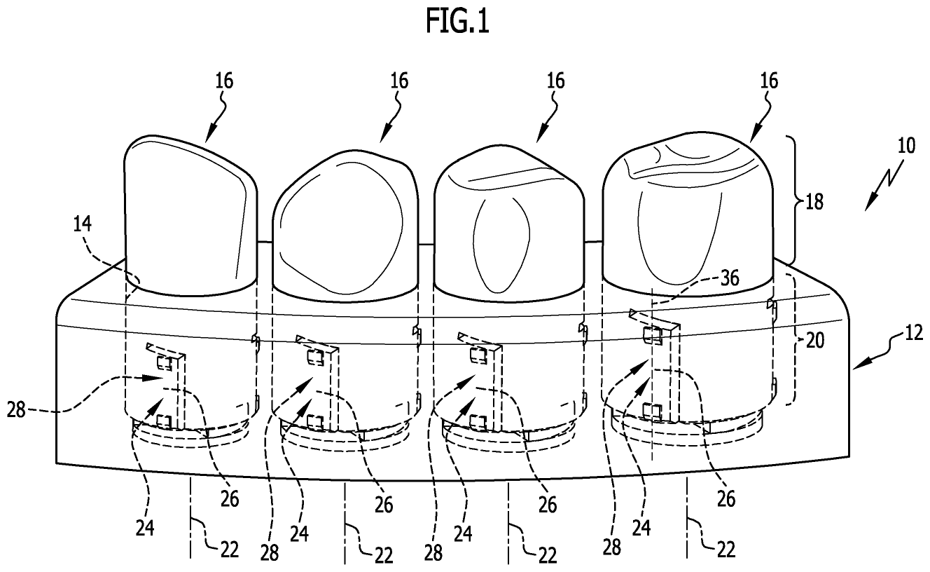

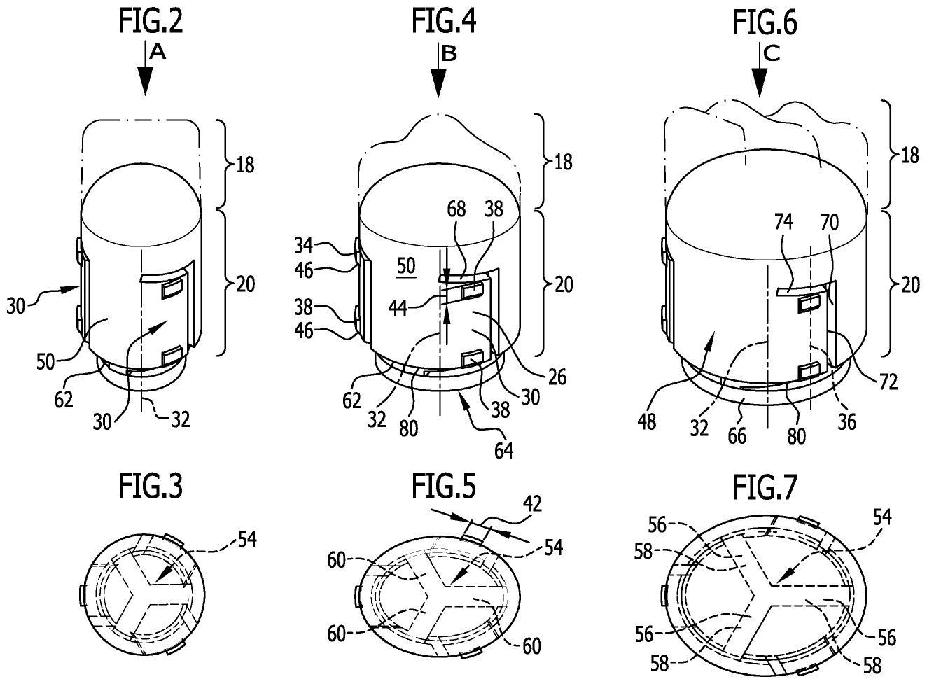

FIG. 1 shows, by way of example, an embodiment of a dental model 10 with four tooth stump receptacles 14, which are formed on a main body 12. A tooth stump 16 with its coupling portion 20 is inserted into each tooth stump receptacle 14 in a force-locking and/or positive-locking manner, so that the tooth stump 16 assumes the coupling position.

Each tooth stump 16 comprises a positioning device 24 for the defined spatial positioning of the tooth stump 16 in the tooth stump receptacle 14 in the coupling position.

The positioning device 24 comprises one or more positioning elements 26 arranged or formed on the coupling portion 20. Each positioning element can be deflected from a basic position against the action of a restoring device 28 into a holding position displaced towards or away from the coupling portion longitudinal axis 22 or substantially towards or away from this axis.

The restoring device 28 comprises one or more restoring elements 30. For example, three restoring elements 30 may be provided. Each positioning element 26 can be deflected from the basic position into the holding position against the action of a restoring element 30.

The restoring elements 30 of the tooth stumps 16 are spring-elastic or substantially spring-elastic.

The positioning elements 26 of the positioning devices 24 of the tooth stumps 16 are held or formed or supported on the coupling portion 20 resiliently.

In the tooth stumps 16 shown in the drawings, the positioning devices 26 are formed in one piece with the coupling portion 20. In particular, they may be monolithic with the coupling portion 20.

In an embodiment, a positioning element 26 may, in particular, comprise or form one or more restoring elements 30.

The positioning elements 20 can be pivoted or rolled in or rolled out, in particular about a deflection axis 32 running parallel to the coupling portion longitudinal axis 22.

Each tooth stump 16 can comprise one, two, three, four or more positioning elements. The tooth stumps 16 depicted in the drawings show examples of three positioning elements 26.

Furthermore, in an embodiment of a tooth stump 16 which comprises two or more positioning elements 26, it may be provided that the positioning elements 26 are arranged or formed evenly distributed over a periphery of the coupling portion 20 in relation to the coupling portion longitudinal axis 22.

Furthermore, in an embodiment of the tooth stump 16, the positioning elements 26 are arranged or formed on the coupling portion 20 so as to be oriented in the same direction in relation to the coupling portion longitudinal axis 22.

The positioning device 24, in an embodiment of the tooth stump 16, may comprise one or more guide elements 34 which are arranged or formed on the positioning element 26.

In the tooth stumps 16 shown by way of example in the drawings, two guide elements 34 are arranged or formed on each positioning element 26. A connecting line 36 of the two or more guide elements 34 runs parallel to the coupling portion longitudinal axis 22.

In an embodiment of a tooth stump 16, one or more guide elements 34 may be in the form of a guide protrusion 38. Alternatively, each guide element 34 may also be configured in the form of a guide groove. The guide groove preferably runs parallel to the coupling portion longitudinal axis 22.

In an embodiment of the tooth stump 16, one or more guide elements 34 are arranged on an outer surface 40 of the positioning element 26 facing away from the coupling portion longitudinal axis 22.

Each guide element 34 can be formed in one piece, in particular may also be monolithic, with the positioning element 26.

The guide protrusion 38 has a width 42 in the peripheral direction in relation to the coupling portion longitudinal axis 22 that is smaller than a length 44 parallel to the coupling portion longitudinal axis 22.

The guide element 24 has a sliding surface 46 facing in the distal direction.

The coupling portion 20 of the tooth stump 16 in an embodiment is in the form of a coupling sleeve 48. This defines a peripheral wall 50.

In an embodiment, the positioning element 26 forms part of the wall 50. A wall thickness 52 of the wall 50 lies in the range from about 0.5 mm to about 1.5 mm. In particular, the wall thickness may be about 1 mm.

A coupling portion stabilising device 54, which is surrounded by the coupling sleeve 48, serves to stabilise the coupling portion 20.

In an embodiment, the coupling portion stabilising device 54 comprises one or more coupling portion stabilising elements 56.

In an embodiment, the coupling portion stabilising elements 56 are in the form of stabilising bars 58 or stabilising wall portions 60. In particular, two, three, four or more coupling portion stabilising elements 46 can be provided to form the coupling portion stabilising device 54.

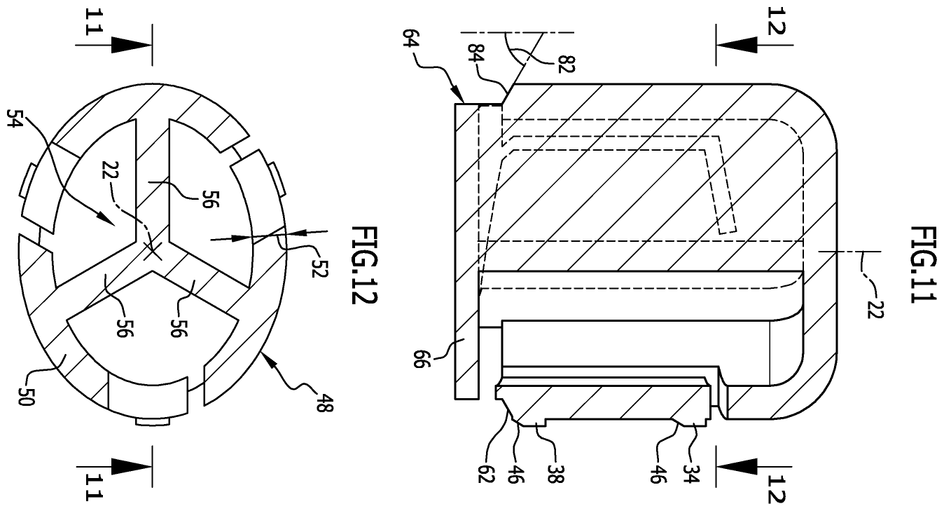

In an embodiment, the two or more coupling portion stabilising elements 56 extend from the coupling portion longitudinal axis 22 to the coupling sleeve 48. This is illustrated by way of example in FIGS. 3, 5, 7, 10 and 12.

In one embodiment, the coupling portion stabilising device 54 is star-shaped or cross-shaped in cross-section in relation to the coupling portion longitudinal axis 22. This is shown by way of example in FIGS. 3, 5, 7, 10 and 12.

In one embodiment, the coupling portion 20 is delimited distally by a peripheral rim 62.

In a further embodiment, the coupling portion 20 comprises a stand element 64 protruding distally beyond the edge 62.

The stand element 64 is preferably planar and comprises a stand plate 66.

The stand element 64 defines a stand element cross-sectional area in relation to the coupling portion longitudinal axis 24. The coupling sleeve 48 defines a coupling sleeve cross-sectional area in relation to the coupling portion longitudinal axis 22. In an embodiment, the stand element cross-sectional area is smaller than the coupling sleeve cross-sectional area.

Furthermore, in one embodiment, the stand element cross-sectional area is geometrically similar to the coupling sleeve cross-sectional area. The coupling sleeve cross-sectional area may be, in essence, of any shape. In one embodiment, the coupling portion 20 has a circular basic cross-sectional shape in relation to the coupling portion longitudinal axis.

Furthermore, in one embodiment, the basic cross-sectional shape of the coupling portion 20 may deviate from a circular shape. A circular basic cross-sectional shape is shown by way of example in FIG. 3. Oval basic cross-sectional shapes are shown by way of example in FIGS. 5, 7, 10 and 12.

In an embodiment of a tooth stump 16, the basic cross-sectional shape is polygonal, in particular triangular, quadrangular or pentagonal.

In an embodiment, the positioning element 26 is formed as part of the wall 50. For this purpose, a gap 68 is formed in the wall 50.

In an embodiment, the gap 68 is U-shaped or substantially U-shaped.

In an embodiment, the gap 68 comprises a gap portion 70 which runs parallel to the coupling portion longitudinal axis 22 and which is adjacent to a free end 72 of the positioning element 26.

A further gap portion 74 of the gap 68 runs in the peripheral direction or substantially in the peripheral direction in relation to the coupling longitudinal axis 22.

In an embodiment, the gap portion 74 is inclined by an angle of inclination 78 in relation to a cross-sectional plane 76 running perpendicularly to the coupling portion longitudinal axis 22.

The angle of inclination 78 in an embodiment lies in a range from 0° to about 20°. In particular, the angle of inclination can be about 10°.

In an embodiment, the positioning element 26 extends as far as a wall end 80 of the wall 50 defined by the edge 62. In this case, the edge 62 is interrupted by one or more gap portions 70 of the gap 68.

In an embodiment, the edge 62 tapers conically in the distal direction and defines an edge surface 84 inclined by a cone angle 82 in relation to the coupling portion longitudinal axis 22.

In an embodiment, the cone angle 82 has a value in a range from 0° to about 75°. In particular, it may be about 60°.

In one embodiment, the stand element 64 is at a spacing from the wall end 80.

The tooth stump 16 is formed in one piece in an embodiment. In particular, it may be monolithic.

In one embodiment, the tooth stump 16 is formed by an additive manufacturing process. In particular, it is formed by 3D printing.

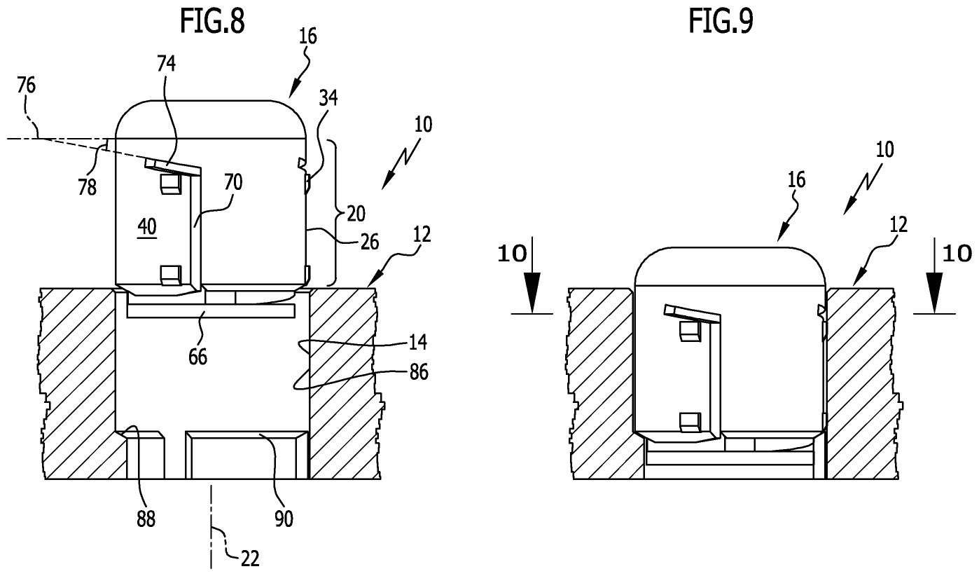

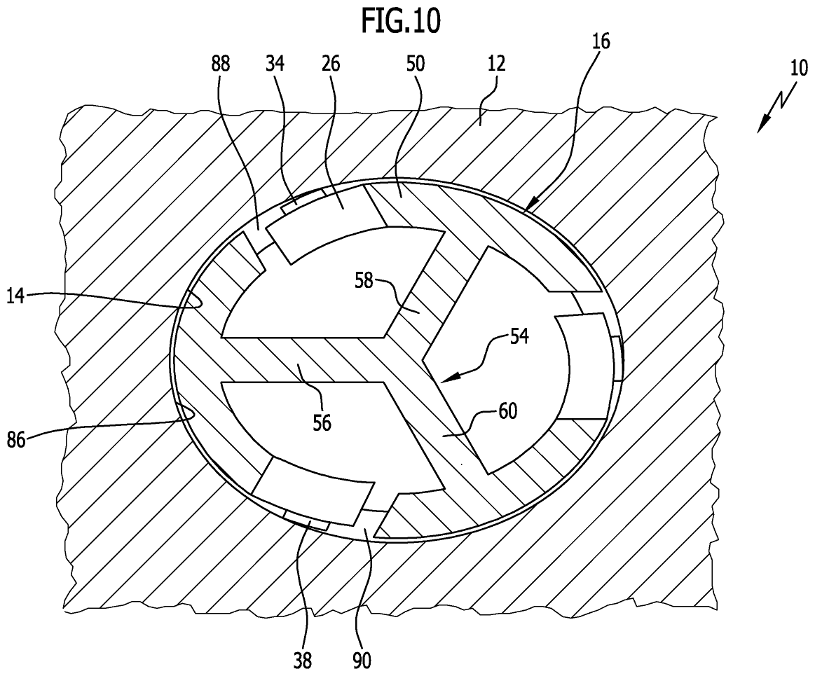

The operating principle of the tooth stump 16 and of the dental model 10 is explained in greater detail below, in particular in conjunction with FIGS. 8 and 9.

To bring the tooth stump 16 into engagement with the main body 12 of the dental model 10, the tooth stump 16 is inserted with its distal end, i.e. with the stand plate 66 at the front, into a tooth stump receptacle 14 of the main body 12. A free cross-sectional area defined by the tooth stump receptacle 14 is dimensioned in such a way that the tooth stump 16 can be completely accommodated with the coupling portion 20 in the tooth stump receptacle 14.

The positioning device 24 is used for a defined positioning of the tooth stump 16 in the tooth stump receptacle 14. The positioning elements 26 carry the guide elements 34, which protrude from the outer surface 40, more specifically to such an extent that they can come into contact with an inner surface 86 of the tooth stump receptacle 14 as the coupling portion 20 is inserted. The insertion of the tooth stump 16 into the tooth stump receptacle 14 is facilitated by the sliding surfaces 46.

To compensate for manufacturing tolerances, a free cross-sectional area of the coupling portion 20, which is defined by the guide protrusions 38, is slightly larger than a free cross-sectional area defining the tooth stump receptacle 14. Due to the sliding of the guide protrusions 38 on the inner surface 86, a restoring force directed towards the coupling portion longitudinal axis 22 acts on the guide elements 34, which in one embodiment are formed in one piece with the positioning element 26.

When the tooth stump 16 is inserted into the tooth stump receptacle 14, the positioning elements 26 are moved against the action of the restoring elements 30 in the direction of the coupling portion longitudinal axis 22, i.e. they are consequently deflected from a basic position, as shown by way of example in FIG. 8, into the holding position, as shown by way of example in FIG. 9.

Due to the action of the restoring elements 30, the guide elements 34 are held with bias against the inner surface 86.

If, for example, three positioning elements with two guide elements 34 each are provided on the tooth stump 16, the tooth stump 16 is automatically centred in a plane perpendicular to the coupling portion longitudinal axis 22 in the tooth stump receptacle 14.

In addition, in order to achieve a clear positioning of the tooth stump 16 in the tooth stump receptacle 14, a cross-sectional shape of the coupling portion 20 that deviates from a circular shape is preferably chosen.

The tooth stump receptacle 14 tapers conically in the region of its distal end and defines a depth stop 88 with a stop surface 90 which tapers conically in the distal direction.

The depth stop 88 cooperates with the edge 62 to delimit a depth of insertion of the tooth stump 16, specifically in particular of the coupling portion 20, into the tooth stump receptacle 14 in a direction parallel to the coupling portion longitudinal axis 22.

In the manner described, each tooth stump 16 can be positioned with high precision in a tooth stump receptacle 14 provided for it. Any manufacturing tolerances in the production of both the main body 12 and the tooth stumps 16 of the dental model 10 can be compensated in all spatial directions by the positioning device.

In an embodiment of the dental model 10, it comprises a main body 12 with at least one tooth stump receptacle 14.

The tooth stump receptacle 14, in an embodiment, is in the form of a tooth stump receiving sleeve 92.

To stabilise the tooth stump receptacle 14, in particular the tooth stump receiving sleeve 92, an embodiment of the dental model comprises a tooth stump receptacle stabilising device 94. This surrounds the tooth stump receiving sleeve 92.

In an embodiment, the tooth stump receptacle stabilising device 94 comprises one or more tooth stump receptacle stabilising elements 96, which are configured in the form of a receptacle stabilising bar 98 or in the form of a receptacle stabilising wall portion 100.

In an embodiment, the tooth stump receptacle stabilising device 94 may comprise a plurality of tooth stump receptacle stabilising elements 96, in particular two, three, four or more tooth stump receptacle stabilising elements 96.

In an embodiment of the dental model 10, the plurality of tooth stump receptacle stabilising elements 96 extends along a receptacle longitudinal axis 102 of the tooth stump receptacle 14, and specifically as far as the tooth stump receiving sleeve 92.

The tooth stump receptacle 14, in an embodiment, comprises a peripheral receptacle wall 104, which forms the tooth stump receiving sleeve 92 or is comprised by it.

In an embodiment of a dental model 10, the receptacle wall 104 has a receptacle wall thickness 106 in a range from about 0.5 mm to about 1.5 mm. In particular, the receptacle wall thickness 106 is about 1 mm.

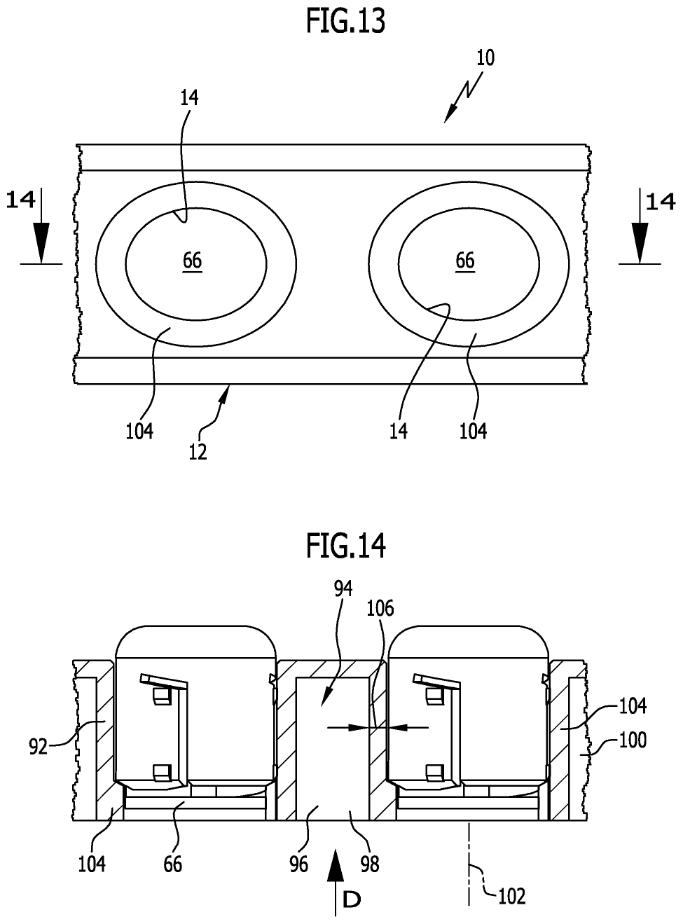

A dental model 10, which does not comprise a receptacle positioning device, is shown schematically and by way of example in FIGS. 1, 8, 9, 10, 13 and 14.

A dental model 10 without a receptacle positioning device can be used in particular in conjunction with the above-described embodiments of tooth stumps 16. The desired positioning in all three spatial directions is achieved here in particular by the positioning device 24 of the tooth stump 16.

If tooth stumps with a coupling portion 20 without positioning device are used, it is advantageous to use a dental model 10 with a receptacle positioning device 108 for the spatial positioning of the tooth stump 16.

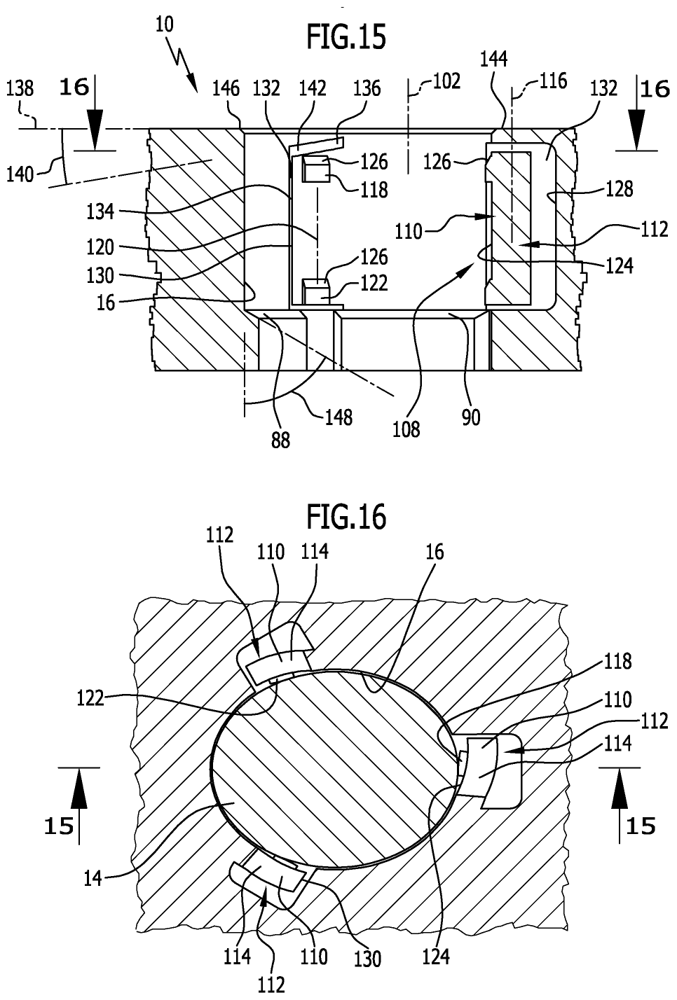

An embodiment of a dental model 10 with a receptacle positioning device 108 is shown schematically in FIGS. 15 and 16.

In an embodiment of the dental model 10 with a receptacle positioning device 108, this comprises one or more receptacle positioning elements 110 formed on the tooth stump receptacle 14. Each receptacle positioning element 110 can be deflected from a basic position against the action of a receptacle restoring device 112 into a holding position displaced towards or away from the receptacle longitudinal axis 102 or substantially towards or away from this axis.

In an embodiment of the dental model 10, the receptacle restoring device 112 may comprise one or more receptacle restoring elements 114, against the action of which one or more receptacle positioning elements 110 can be deflected from a basic position into the holding position.

In an embodiment, the one or more receptacle restoring elements 114 are spring-elastic or substantially spring-elastic.

Each receptacle positioning element 110 is held or formed or supported on the tooth stump receptacle 14 resiliently.

In an embodiment of the dental model 10, the receptacle positioning element 110 comprises one or more receptacle restoring elements 114. In particular, these can be formed in one piece, for example may be monolithic.

In an embodiment of a dental model 10, the receptacle positioning element 110 can be pivoted or rolled in or out about a receptacle deflection axis 116 running parallel or transversely, in particular perpendicularly, to the receptacle longitudinal axis 102. The receptacle positioning element 110 can, in particular, be configured in the form of a wing or tab and can be oriented in a transverse direction, in particular oriented in the peripheral direction in relation to the receptacle longitudinal axis 102.

In particular, the dental model 10 may comprise one, two, three, four or more receptacle positioning elements 110.

In an embodiment of a dental model 10, as shown schematically in FIGS. 15 and 16, a total of three receptacle positioning elements 110 are provided.

In particular, the dental model 10 comprises a plurality of receptacle positioning elements 110, for example two, three or four.

In an embodiment, the receptacle positioning elements 110 are arranged or formed evenly distributed over a periphery of the tooth stump receptacle 14. The plurality of receptacle positioning elements 110, in particular in an embodiment, can be arranged or formed on the tooth stump receptacle 14 so as to be oriented in the same direction in relation to the receptacle longitudinal axis 102. For example, the receptacle positioning elements 110 may all be formed in the same direction in the form of wings facing in the peripheral direction.

In an embodiment, the receptacle positioning device 108 comprises a receptacle guide element 118, which is arranged or formed on the receptacle positioning element 110.

In an embodiment of a dental model 10, two or more receptacle guide elements 118 may be arranged or formed on a receptacle positioning element 110.

In an embodiment, a connecting line 120 of two or more receptacle guide elements 118 runs parallel to the receptacle longitudinal axis 102.

The one or more receptacle guide elements 118, in an embodiment, are configured in the form of a receptacle guide protrusion 122 or in the form of a receptacle guide groove.

In an embodiment, the receptacle guide element 118 is arranged or formed on an inner surface 124 of the receptacle positioning element 110 facing towards the receptacle longitudinal axis.

In order to facilitate the insertion of a tooth stump 16 into the tooth stump receptacle 14, the receptacle guide element 118 in one embodiment has a receptacle sliding surface 126 facing in the proximal direction.

In an embodiment of a dental model 10, the receptacle positioning element 110 forms part of the receptacle wall 104. In particular, the receptacle positioning element may be arranged in or may extend into a recess 128 in the receptacle wall 104.

In an embodiment, the receptacle positioning element 110 has a free receptacle end 130 and is formed by a receptacle gap 132 in the receptacle wall 104.

The receptacle gap 132, in an embodiment, is U-shaped or substantially U-shaped.

In an embodiment, the receptacle gap 132 comprises a receptacle gap portion 134 running parallel or substantially parallel to the receptacle longitudinal axis 102. In addition, the receptacle gap 132 may comprise a receptacle gap portion 136 running in the peripheral direction or substantially in the peripheral direction in relation to the receptacle longitudinal axis 102.

In an embodiment of a dental model 10, the receptacle gap 132 has a receptacle gap portion 142 which is inclined by a receptacle angle of inclination 140 in the peripheral direction in relation to a receptacle cross-sectional plane 138 running perpendicularly to the receptacle longitudinal axis 102.

The receptacle angle of inclination 140 is preferably in a range from 0° to about 20°. In particular, it may be about 10°.

In one embodiment, the receptacle wall 104 has a proximal receptacle wall end 144. The receptacle positioning element 110 may extend, in particular, to the receptacle wall end 144.

In an embodiment of a dental model 10, the receptacle wall end 144 may be in the form of a peripheral receptacle edge 146 of the receptacle wall 104. The receptacle edge 146 may be interrupted by at least one receptacle gap portion of the at least one receptacle gap 132.

Furthermore, the stop face 90 of the depth stop 88 in an embodiment of the dental model 10 is inclined by a receptacle cone angle 148 in relation to the receptacle longitudinal axis 102. In preferred embodiments, the receptacle cone angle has a value in a range from 0° to about 75°. In particular it may be 60°.

In order to enable a clear positioning of the tooth stump 16 in the tooth stump receptacle 14 in the peripheral direction, the tooth stump receptacle 14 has a receptacle basic cross-sectional shape in relation to the receptacle longitudinal axis 102 which deviates from a circular shape. The basic cross-sectional shape is preferably oval, as shown by way of example in FIG. 16, or polygonal, in particular triangular, quadrangular or pentagonal.

The main body 12 is formed in one piece, in particular is monolithic, in an embodiment of a dental model 10.

In an embodiment, the main body 12 is formed by an additive manufacturing process, for example by 3D printing from a plastics material.

In accordance with an embodiment, the dental model 10 may have a receptacle positioning device 108 on one or all tooth stump receptacles 14. In particular, tooth stumps 16 with or without a positioning device 24 can be inserted into these tooth stump receptacles 14.

The described embodiments of dental models 10, in particular the described embodiments of main bodies 12 and tooth stumps 16, enable the formation of working and control models for the production of dental prostheses, wherein individual modelled teeth can be individually exchanged and prepared by exchanging tooth stumps 16 as necessary.

All the components described can be produced, in particular, by additive manufacturing processes based on three-dimensional contour data, which contour data can be produced by means of imaging processes, for example, images of a human or animal dentition obtained using ultrasound or X-rays.

### LIST OF REFERENCE NUMERALS

10 Dental model
12 Main body
14 Tooth stump receptacle
16 Tooth stump
18 Tooth portion
20 Coupling portion
22 Coupling portion longitudinal axis
24 Positioning device
26 Positioning element
28 Restoring device
30 Restoring element
32 Deflection axis
34 Guide element
36 Connecting line
38 Guide protrusion
40 Outer surface
42 Width
44 Length
46 Sliding surface
48 Coupling sleeve
50 Wall
52 Wall thickness
54 Coupling portion stabilising device
56 Coupling portion stabilising element
58 Stabilising bar
60 Stabilising wall portion
62 Edge
64 Stand element
66 Stand plate
68 Gap
70 Gap portion
72 Free end
74 Gap portion
76 Cross-sectional plane
78 Angle of inclination
80 Wall end
82 Cone angle
84 Edge surface
86 Inner surface
88 Depth stop
90 Stop surface
92 Tooth stump receiving sleeve
94 Tooth stump receptacle stabilising device
96 Tooth stump receptacle stabilising element
98 Receptacle stabilising bar
100 Receptacle stabilising wall portion
102 Receptacle longitudinal axis
104 Receptacle wall
106 Receptacle wall thickness
108 Receptacle positioning device
110 Receptacle positioning element
112 Receptacle restoring device
114 Receptacle restoring element
116 Receptacle deflection axis
118 Receptacle guide element
120 Connecting line
122 Receptacle guide protrusion
124 Inner surface
126 Receptacle sliding surface
128 Recess
130 Receptacle end
132 Receptacle gap
134 Receptacle gap portion
136 Receptacle gap portion
138 Receptacle cross-sectional plane
140 Receptacle angle of inclination
142 Receptacle gap portion
144 Receptacle wall end
146 Receptacle edge
148 Receptacle cone angle

What is claimed is:

1. A tooth stump for a dental model, said dental model comprises at least one tooth and at least one tooth stump receptacle for at least partially receiving the tooth stump, said tooth stump comprises a tooth portion in the form of a human or animal tooth and a coupling portion defining a coupling portion longitudinal axis for force-locking and/or positive-locking engagement with the at least one tooth stump receptacle of the dental model in a coupling position, the tooth stump comprising a positioning device for defined spatial positioning of the tooth stump in the tooth stump receptacle in the coupling position, wherein the positioning device comprises at least one positioning element formed on the coupling portion, wherein the at least one positioning element can be deflected from a basic position against the action of a restoring device into a holding position displaced towards or away from the coupling portion longitudinal axis or substantially towards or away from the coupling portion longitudinal axis, wherein the at least one positioning element, when it is in the holding position, is deflected from the basic position against the action of the restoring device, wherein the positioning device comprises at least one guide element, and wherein the at least one guide element is arranged or formed on the at least one positioning element.

2. The tooth stump in accordance with claim 1, wherein the restoring device comprises at least one restoring element, against the action of which the at least one positioning element can be deflected into the holding position,
wherein in particular
a) the at least one restoring element is spring-elastic or substantially spring-elastic
and/or
b) the at least one positioning element comprises or forms the at least one restoring element.

3. The tooth stump in accordance with claim 1, wherein
a) the at least one positioning element is held or formed or supported on the coupling portion resiliently
and/or
b) the at least one positioning element can be pivoted or rolled in or out about a deflection axis running parallel or transversely, in particular perpendicularly, to the coupling portion longitudinal axis
and/or
c) the tooth stump comprises one, two, three, four or more positioning elements
and/or
d) a plurality of positioning elements is provided, in particular two, three or four, and wherein the positioning elements are arranged or formed evenly distributed over a periphery of the coupling portion,
wherein in particular the plurality of positioning elements is arranged or formed on the coupling portion so as to be oriented in the same direction in relation to the coupling portion longitudinal axis.

4. The tooth stump in accordance with claim 1, wherein two or more guide elements are arranged or formed on the at least one positioning element,
wherein in particular a connecting line of the two or more guide elements runs parallel to the coupling portion longitudinal axis.

5. The tooth stump in accordance with claim 1, wherein
a) the at least one guide element is configured in the form of a guide protrusion or in the form of a guide groove
and/or
b) the at least one guide element is arranged or formed on an outer surface of the at least one positioning element facing away from the coupling portion longitudinal axis
and/or
c) the at least one guide element has a sliding surface facing in the distal direction
and/or
d) the coupling portion is configured in the form of a coupling sleeve
and/or
e) the coupling portion comprises a coupling portion stabilising device,
wherein in particular the coupling portion stabilising device is surrounded by the coupling sleeve
and/or
comprises at least one coupling portion stabilising element and/or is star-shaped or cross-shaped in cross-section in relation to the coupling portion longitudinal axis.

6. The tooth stump in accordance with claim 1, wherein the coupling portion is delimited on the distal side by a peripheral edge and comprises a stand element protruding distally beyond the edge, wherein in particular the stand element
a) is planar
and/or
b) defines a stand element cross-sectional area in relation to the coupling portion longitudinal axis, wherein the coupling sleeve defines a coupling sleeve cross-sectional area, and
the stand element cross-sectional area is smaller than the coupling sleeve cross-sectional area
and/or is geometrically similar to the coupling sleeve cross-sectional area.

7. The tooth stump in accordance with claim 1, wherein the coupling portion comprises a peripheral wall, and wherein the at least one positioning element forms part of the wall,
wherein in particular
a) the wall has a wall thickness in a range from about 0.5 mm to about 1.5 mm, in particular about 1 mm
and/or
b) the at least one positioning element has a free end and is formed by a gap in the wall,
wherein in particular the gap:
is U-shaped or substantially U-shaped
and/or comprises a gap portion running parallel or substantially parallel to the coupling portion longitudinal axis
and/or
a gap portion running in the peripheral direction or substantially in the peripheral direction in relation to the coupling portion longitudinal axis
and/or
has a gap portion inclined by an angle of inclination in the peripheral direction in relation to a cross-sectional plane running perpendicularly to the coupling portion longitudinal axis,
and/or
c) the wall has a distal wall end directed away from the tooth portion, and wherein the at least one positioning element extends as far as the wall end,
wherein the wall end is configured in the form of a peripheral edge of the wall and/or the stand element is spaced from the wall end.

8. The tooth stump in accordance with claim 1, wherein
a) the coupling portion has a basic cross-sectional shape in relation to the coupling portion longitudinal axis which deviates from a circular shape,
wherein in particular the basic cross-sectional shape is oval or polygonal, in particular triangular, quadrangular or pentagonal,
and/or
b) the tooth stump is formed in one piece, in particular is monolithic
and/or
c) the tooth stump is formed by an additive manufacturing process, in particular by 3D printing
and/or
d) the tooth stump is formed from a plastics material.

9. A dental model, in particular as a working and control model for the production of dental prostheses, said dental model comprises a main body with at least one tooth stump receptacle for at least partially receiving a tooth stump, said tooth stump receptacle defines a receptacle longitudinal axis and is configured for force-locking and/or positive-locking engagement with the tooth stump in a coupling position, the tooth stump receptacle comprising a receptacle positioning device for the defined spatial positioning of the tooth stump in the tooth stump receptacle in the coupling position, wherein the receptacle positioning device comprises at least one receptacle positioning element formed on the tooth stump receptacle, wherein the at least one receptacle positioning element can be deflected from a basic position against the action of a receptacle restoring device into a holding position displaced towards or away from the receptacle longitudinal axis or substantially towards or away from the receptacle longitudinal axis, wherein the at least one receptacle positioning element, when it is in the holding position, is deflected from the basic position against the action of the receptacle restoring device, wherein the receptacle positioning device comprises at least one receptacle guide element, and wherein the at least one receptacle guide element is arranged or formed on the at least one receptacle positioning element.

10. The dental model in accordance with claim 9, wherein the receptacle restoring device comprises at least one receptacle restoring element, against the action of which the at least one receptacle positioning element can be deflected into the holding position,
wherein in particular
a) the at least one receptacle restoring element is spring-elastic or substantially spring-elastic
and/or
b) the at least one receptacle positioning element comprises or forms the at least one receptacle restoring element.

11. The dental model in accordance with claim 9, wherein
a) the at least one receptacle positioning element is held or formed or supported on the tooth stump receptacle resiliently
and/or
b) the at least one receptacle positioning element can be pivoted or rolled in or rolled out about a receptacle deflection axis running parallel or transversely, in particular perpendicularly, to the receptacle longitudinal axis
and/or
c) the dental model comprises one, two, three, four or more receptacle positioning elements
and/or
d) a plurality of receptacle positioning elements is provided, in particular two, three or four, and wherein the receptacle positioning elements are arranged or formed evenly distributed over a periphery of the tooth stump receptacle,
wherein in particular the plurality of receptacle positioning elements is arranged or formed on the tooth stump receptacle so as to be oriented in the same direction in relation to the receptacle longitudinal axis.

12. The dental model in accordance with claim 9, wherein two or more receptacle guide elements are arranged or formed on the at least one receptacle positioning element,
wherein in particular a connecting line of the two or more receptacle guide elements runs parallel to the receptacle longitudinal axis.

13. The dental model in accordance with claim 9, wherein
a) the at least one receptacle guide element is configured in the form of a receptacle guide protrusion or in the form of a receptacle guide groove
and/or
b) the at least one receptacle guide element is arranged or formed on an inner surface of the at least one receptacle positioning element facing towards the receptacle longitudinal axis
and/or
c) the at least one receptacle guide element has a receptacle sliding surface facing in the proximal direction
and/or
d) the tooth stump receptacle is configured in the form of a tooth stump receiving sleeve
and/or
e) the tooth stump receptacle comprises a tooth stump receptacle stabilising device,
wherein in particular the tooth stump receptacle stabilising device surrounds the tooth stump receiving sleeve and/or comprises at least one tooth stump receptacle stabilising element.

14. The dental model in accordance with claim 9, wherein the tooth stump receptacle comprises a peripheral receptacle wall, and wherein the at least one receptacle positioning element forms part of the receptacle wall,
wherein in particular
a) the receptacle wall has a receptacle wall thickness in a range from about 0.5 mm to about 1.5 mm, in particular about 1 mm,
and/or
b) the at least one receptacle positioning element has a free receptacle end and is formed by a receptacle gap in the receptacle wall,
wherein in particular the receptacle gap:
is U-shaped or substantially U-shaped
and/or
comprises a receptacle gap portion running parallel or substantially parallel to the receptacle longitudinal axis
and/or
comprises a receptacle gap portion running in the peripheral direction or substantially in the peripheral direction in relation to the receptacle longitudinal axis
and/or
has a receptacle gap portion which is inclined by a receptacle angle of inclination in the peripheral direction in relation to a receptacle cross-sectional plane running perpendicularly to the receptacle longitudinal axis
and/or
c) the receptacle wall has a proximal receptacle wall end, and wherein the at least one receptacle positioning element extends as far as the receptacle wall end,
wherein in particular the receptacle wall end is configured in the form of a peripheral receptacle edge of the receptacle wall.

15. The dental model in accordance with claim 9, wherein
a) the tooth stump receptacle has a receptacle basic cross-sectional shape in relation to the receptacle longitudinal axis which deviates from a circular shape, wherein in particular the receptacle basic cross-sectional shape is oval or polygonal, in particular triangular, quadrangular or pentagonal,
and/or
b) the main body is formed in one piece, in particular is monolithic,
and/or
c) the main body is formed by an additive manufacturing process, in particular by 3D printing,
and/or
d) the main body is made of a plastics material
and/or
e) the main body is configured in the form of a part of a jaw.

16. The dental model in accordance with claim 9, further comprising
a) a tooth stump which is coupled to the main body in the coupling position and which comprises a tooth portion in the form of a tooth and a coupling portion, the coupling portion of the tooth stump being received at least partially, in particular completely, in the at least one tooth stump receptacle
or
b) at least one tooth stump at least partially received in the tooth stump receptacle,
wherein in particular the tooth stump comprises a tooth portion in the form of a human or animal tooth and a coupling portion defining a coupling portion longitudinal axis for force-locking and/or positive-locking engagement with the at least one tooth stump receptacle of the dental model in a coupling position, the tooth stump comprising a positioning device for defined spatial positioning of the tooth stump in the tooth stump receptacle in the coupling position, wherein the positioning device comprises at least one positioning element formed on the coupling portion, wherein the at least one positioning element can be deflected from a basic position against the action of a restoring device into a holding position displaced towards or away from the coupling portion longitudinal axis or substantially towards or away from the coupling portion longitudinal axis, wherein the at least one positioning element, when it is in the holding position, is deflected from the basic position against the action of the restoring device, wherein the positioning device comprises at least one guide element, and wherein the at least one guide element is arranged or formed on the at least one positioning element.

17. A dental model, in particular as a working and control model for the production of dental prostheses, said dental model comprises a main body and at least one tooth stump coupled to the main body in a coupling position, said tooth stump comprises a tooth portion in the form of a tooth and a coupling portion, said main body has at least one tooth stump receptacle, in which the coupling portion of the tooth stump is received at least partially, in particular completely, wherein the tooth stump comprises a tooth portion in the form of a human or animal tooth and a coupling portion defining a coupling portion longitudinal axis for force-locking and/or positive-locking engagement with the at least one tooth stump receptacle of the dental model in a coupling position, the tooth stump comprising a positioning device for defined spatial positioning of the tooth stump in the tooth stump receptacle in the coupling position, wherein the positioning device comprises at least one positioning element formed on the coupling portion, wherein the at least one positioning element can be deflected from a basic position against the action of a restoring device into a holding position displaced towards or away from the coupling portion longitudinal axis or substantially towards or away from the coupling portion longitudinal axis, wherein the at least one positioning element, when it is in the holding position, is deflected from the basic position against the action of the restoring device, wherein the positioning device comprises at least one guide element, and wherein the at least one guide element is arranged or formed on the at least one positioning element.
